(19) United States
(12) Patent Application Publication
(10) Pub. No.: US 2015/0026053 A1
(43) Pub. Date: Jan. 22, 2015

(54) ONLINE BANKING ALERTS

(71) Applicant: BANK OF AMERICA CORPORATION, Charlotte, NC (US)

(72) Inventors: Matthew A. Calman, Charlotte, NC (US); William E. Kelley, Charlotte, NC (US); Chris Purvis, Waxhaw, NC (US); Dipika Jain, Charlotte, NC (US); Michael E. Toth, Charlotte, NC (US)

(21) Appl. No.: 13/946,304

(22) Filed: Jul. 19, 2013

(51) Int. Cl. G06Q 20/10

(52) U.S. Cl. CPC G06Q 20/108
USPC 705/42

(57) ABSTRACT

Disclosed is a system and associated method for providing alerts regarding a customer's online banking account. The system typically includes a processor, a memory, and an online banking module stored in the memory. The module is typically configured for initially associating a mobile device with the customer's online banking account. In addition, the module is typically configured for subsequently determining whether a computing device has engaged in a predefined online banking transaction associated with the customer's online banking account and transmitting a notification that the computing device has engaged in the predefined online banking transaction to the mobile device based on determining that (i) the computing device has engaged in a predefined online banking transaction associated with the customer's online banking account and (ii) the mobile device is associated with the customer's online banking account.

### FIELD OF THE INVENTION

The present invention embraces a system for providing alerts regarding a customer's mobile and online banking account. The system typically includes a processor, a memory, and an online banking module stored in the memory. The online banking module is typically configured to transmit alerts regarding the customer's online banking account to a mobile device enrolled with the customer's online banking account.

### BACKGROUND

Over the last few years, the use of online banking (e.g., mobile banking) has increased dramatically. Online banking provides users with many useful features that typically include, among other things, allowing users to view account balances, view transaction history, view statements, transfer funds, and pay bills. That said, a need exists for users to have increased control over their online banking accounts.

### SUMMARY

In one aspect, the present invention embraces a method of providing alerts regarding a customer's online banking account. The present invention also embraces a system (e.g., an online banking system) configured for performing one or more of the steps of the method.

The method typically includes, initially, receiving an association request from a customer to associate a first mobile device with the customer's online banking account. The association request typically includes device identification information associated with the first mobile device and first account identification information associated with the customer's online banking account. Next, the device identification information associated with the first mobile device is associated with the customer's online banking account, and an association record based on the device identification information associated with the first mobile device and the first account identification information associated with the customer's online banking account is created.

Subsequently, it is determined whether a computing device has engaged in a predefined online banking transaction associated with the customer's online banking account. A database of records is searched to determine if a mobile device is associated with the customer's online banking account. Then, a notification that the computing device has engaged in the predefined online banking transaction is transmitted to the first mobile device based on determining that (i) the computing device has engaged in a predefined online banking transaction associated with the customer's online banking account and (ii) the first mobile device is associated with the customer's online banking account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a method for enrolling a customer's mobile device with the customer's online banking account in accordance with an aspect of the present invention;

FIG. 2 depicts a method for sending alerts about a customer's online banking account to an enrolled mobile device in accordance with an aspect of the present invention;

FIG. 3 depicts an online banking system and environment in accordance with an aspect of the present invention;

FIG. 4 schematically depicts a customer's mobile device in accordance with an aspect of the present invention;

FIG. 5 schematically depicts a customer's computing device in accordance with an aspect of the present invention; and

FIG. 6 schematically depicts an online banking system in accordance with an aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

As used herein, an “online banking account” is an account that is associated with one or more user accounts at a financial institution. For example, the user may have an online banking account that is associated with the user's checking account, savings account, investment account, and credit account at a particular financial institution. A username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone or tablet). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded). In other embodiments, the “customer” may refer to the user.

In one aspect, the present invention generally relates to a system (e.g., an online banking system) for providing alerts regarding a customer's mobile and online banking account. More particularly, the present invention typically provides alerts to a mobile device associated with the customer's online banking account. These alerts may provide notice to the customer that another device is trying to access their online banking account or engage in certain transactions (e.g., transferring funds). In some embodiments, the associated mobile device may be used to control access to the customer's online banking account. In other words, the mobile device may act as a remote control for the customer's online banking account.

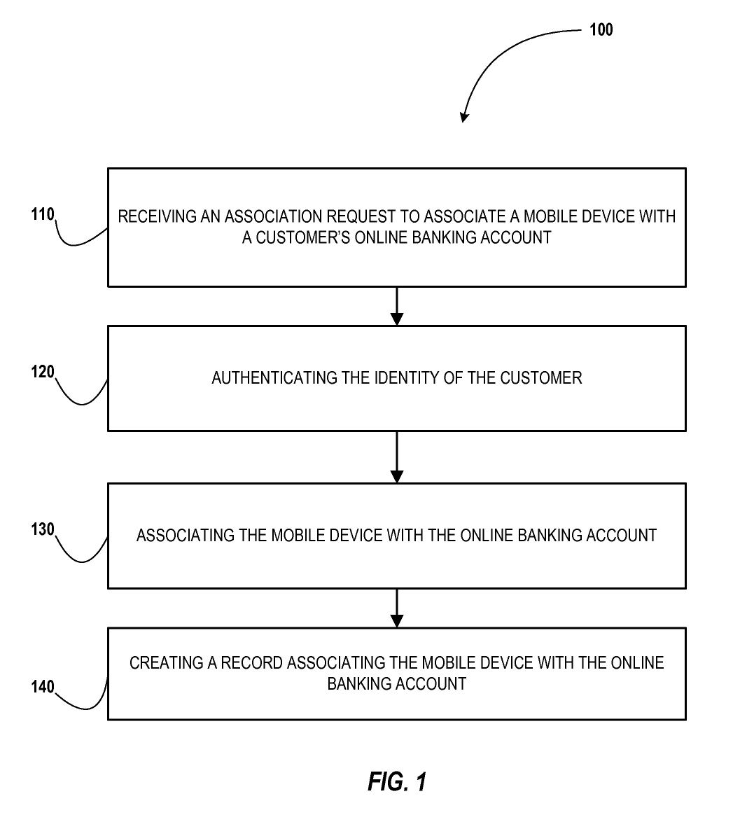

Referring now to FIG. 1, a general process flow 100 is provided for enrolling (e.g., associating) a customer's mobile device with an online banking account. This method is typically performed by an online banking system. Although enrolling a mobile device is discussed below, it is within the scope of the present invention to enroll other computing devices such as a personal computer.

At block 110, the method includes receiving (e.g., at an online banking system) an association request to associate (e.g., enroll) the mobile device (e.g., a laptop, personal digital assistant (PDA), cell phone, smart phone, tablet, mp3 player, or any other suitable electronic device) with the customer's online banking account. The association request may be submitted by the mobile device via a mobile application (e.g., a mobile banking application) or via a mobile banking website. For example, a mobile banking application downloaded onto the mobile device may prompt the customer to enroll the mobile device as an online banking remote control.

The association request typically includes device identification information associated with the mobile device and account identification information associated with the customer's online banking account.

The device identification information associated with the mobile device may be any information sufficient to generate a device “fingerprint,” or unique signature of the customer's mobile device. Device identification information may be collected from a variety of sources. In some embodiments, the device identification information includes an identification code. The identification code may be but is not limited to a serial number or an item number of the device. In some embodiments, the device identification information may be associated with a chip associated with the mobile device. The chip may be but is not limited to a subscriber identification module (SIM) card, removable hard drive, processor, microprocessor, or the like. In other embodiments, the device identification information may be associated with a removable part of the mobile device. Removable parts include but are not limited to detachable keyboards, battery covers, cases, hardware accessories, or the like. Removable parts may contain serial numbers or part numbers. In alternative embodiments, a unique key, code, or piece of software provided by a financial institution may be downloaded onto the mobile device. This unique key, code, or piece of software may then serve as device authentication information. In some embodiments, device identification information may need to be entered manually at the mobile device. For example, the online banking system may prompt the customer for manual entry of the device identification information (e.g., a serial number, an identification code, an International Mobile Station Equipment Identity (IMEI), a phone number, a chip, a removable part, or similar pieces of device identification information). In other embodiments, device identification information may not be based on user input received at the mobile device. Instead, the device identification information may be automatically provided by the mobile device. In yet another embodiment, the mobile device may provide the information without requiring user input after receiving a request from the online banking system for the identification information.

The account identification information may be any information sufficient to identify the customer's online banking account. In some embodiments, the account identification information may include, but is not limited to, at least one of a customer name, contact information, a username, a password, a PIN number, a unique identification number associated with the customer, social network information, an account number, or a card number. In some embodiments, the account identification information may be proprietary to the financial institution, such as an account number, a reference number to an account, a client number, or the like. In other embodiments, the account identification information may be public information, such as a phone number, mailing address, email address, or the like. The account identification information may be automatically provided by the mobile device. Alternatively, the customer may manually provide this information. For example, the customer may enter a username and a password associated with the customer's online banking account. The username and password may be provided in conjunction with the association request or may have been previously provided at the beginning of an online banking session, such as a mobile banking session (e.g., in order to log into a mobile banking application or mobile banking website). Accordingly, the account identification information may include information related to an online banking session (e.g., a mobile banking session).

At block 120, the method typically includes authenticating the identity of the customer. For example, the online banking system may prompt the customer to enter authentication information (e.g., customer identification information) such as a username, a password, a personal identification number (PIN), a passcode, biometric information (e.g., voice authentication, a fingerprint, and/or a retina scan), or an answer to a security question. This authentication information may be used to authenticate the identity of the customer (e.g., determine that the authentication information is associated with the account) and determine that the customer has authority to access the online banking account. In one embodiment, authentication information may include a unique intrinsic user activity, such as making a predefined motion with a customer device. Using a unique intrinsic user activity for authentication is described in commonly assigned U.S. Pat. No. 8,116,453, which is hereby incorporated by reference in its entirety. In some embodiments, this step 120 of authenticating the identity of the customer may be part of a strong authentication process. A strong authentication process is a security measure that requires two or more authentication steps. In this regard, the customer may have previously provided a username and password when initiating a mobile banking session (e.g., when submitting an online banking session initiation request) or when submitting the association request. Accordingly, in step 120, the customer may be prompted to enter additional authentication information (e.g., additional identification information), such as a PIN, biometric information, and/or an answer to a security question in order to further verify the identity of the customer (e.g., determine that the additional authentication information is associated with the online banking account).

At block 130, the mobile device is associated (e.g., enrolled) with the customer's online banking account. In this regard, the account identification information and customer identification information provided by the customer is typically used to locate records (e.g., customer account information) in the online banking system associated with the customer's online banking account. Once the records associated with the customer's online banking account are located, an association is made between the identity of the mobile device and the customer's online banking account. Once the association is made, at block 140, the online banking system typically creates an association record in memory of the association between the identity of the mobile device and the customer's online banking account.

This association between the identity of the mobile device and the customer's online banking account indicates that alerts regarding the customer's online banking account should be sent to the mobile device. In addition, this association between the identity of the mobile device and the customer's online banking account indicates that the mobile device has permission to act as a remote control for the customer's online banking account. Furthermore, this association between the mobile device and the customer's online banking account may be used to associate the mobile device with the customer's identity. Accordingly, the identity of the mobile device may be used to identify the customer and to identify the customer's online banking account.

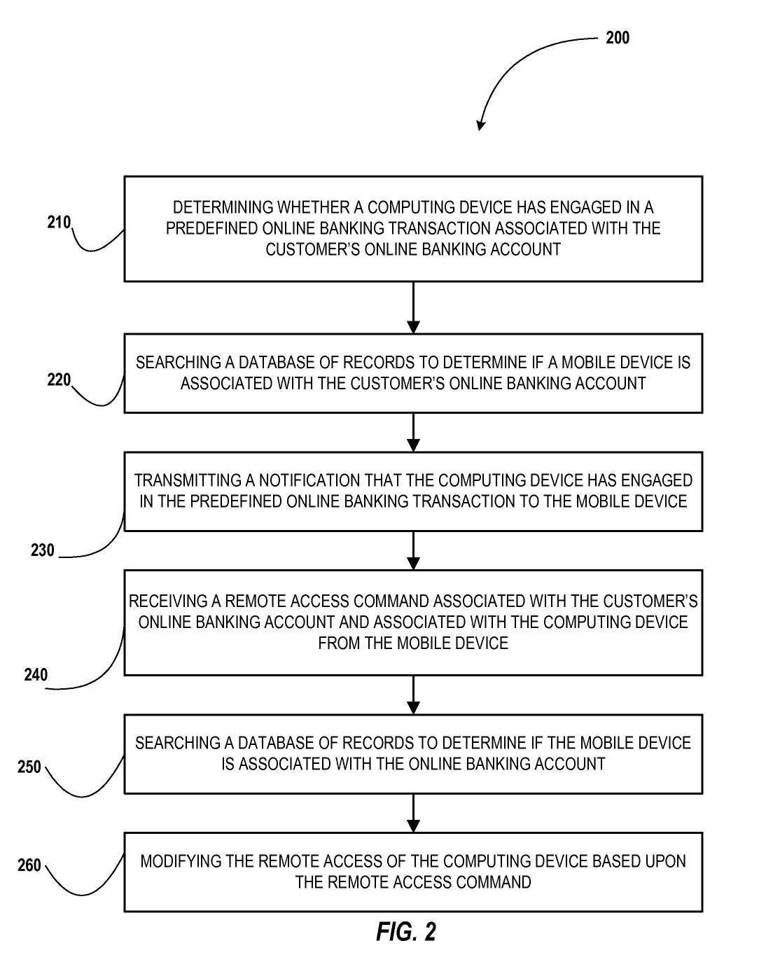

In one embodiment, alerts regarding the customer's online banking account may be sent to an enrolled mobile device. Prompted by such alerts, the customer may then use the enrolled mobile device to control access to the online banking account. In this regard, FIG. 2 depicts a method 200 of sending alerts to an enrolled (e.g., associated) mobile device. This method is typically performed by an online banking system.

At block 210, the method includes determining (e.g., with an online banking system) whether another computing device (e.g., a laptop, personal computer, tablet computer, mobile device, or other suitable electronic device) has engaged in a predefined online banking transaction associated with the customer's online banking account. The computing device may use a mobile application (e.g., a mobile banking application) or a mobile banking website in order to engage in the predefined online banking transaction. For example, a mobile banking application downloaded onto the computing device may be used to engage in the predefined online banking transaction.

The predefined online banking transaction may be any activity that may be initiated, performed, and/or completed using the customer's online banking account. By way of example, the predefined online banking transaction may be initiating an online banking session, terminating an online banking session, paying bills, viewing account statements, viewing account balances, depositing funds, withdrawing funds, or transferring funds (e.g., transferring funds to a predefined transferee). The predefined online banking transaction may be any online banking transaction performed by a predefined computing device. The predefined online banking transaction may be any online banking transaction performed by the computing device from a predefined location (e.g., within a predefined distance from a predefined location or within a predefined geo-fence). For example, the predefined online banking transaction may be any online banking transaction performed when the computing device is located or not located at a predefined location. In this regard, many computing devices are capable of recognizing and transmitting the GPS coordinates for the position of the computing device. In some situations, a computing device may be capable of recognizing a network associated with a particular location, such as a customer's home or business wireless network, and use that information to transmit or otherwise make available the location information associated with the computing device. The predefined online banking transaction may be any online banking transaction that performed or not performed on a predefined network (e.g., on or not on a particular cellular or wireless network). The predefined online banking transaction may be any online banking transaction performed during a predefined period of time (e.g., during a certain day or time of day). The predefined online banking transaction may be may be any online banking transaction engaged in by a sub-account associated with the customer's online banking account. The predefined online banking transaction may be any combination of the foregoing. The predefined online banking transaction may be defined by the financial institution or may be defined by the customer (e.g., by using an online banking application or online banking website). Information regarding the predefined online banking transaction(s) may be stored in one or more records in memory. It is within the scope of the present invention for there to be more than one predefined online banking transaction.

In the event that the predefined online banking transaction relates to online banking transactions performed by a predefined computing device, device identification information associated with the predefined computing device may be collected (e.g., automatically by the online banking system during an online banking session). For example, the online banking system may collect device identification information for each device that logs into the customer's online banking account. Thereafter, the online banking system may present a list of every device that has logged into the customer's online banking account to the customer (e.g., via the customer's mobile device) after which the customer can select one or more devices to receive alerts about.

In order to determine (e.g., detect) whether a device has engaged in a predefined online banking transaction associated with the customer's online banking account, each time the online banking system receives an indication of an online banking transaction (e.g., a request to initiate an online banking session), the online banking system may then compare such online banking transaction against one or more predefined online banking transactions (e.g., stored in a record in memory) to determine if such online banking transaction is within the scope of a predefined online banking transaction.

Next, at block 220, the online banking system searches a database of records to determine if any mobile device is associated (e.g., enrolled) with the online banking account.

If the computing device has engaged in the predefined online banking transaction associated with the customer's online banking account, and if a mobile device is associated with the online banking account, then, at block 230, the online banking system transmits an alert (e.g., notification) to the associated mobile device. This alert typically includes an indication that the computing device has engaged in the predefined online banking transaction. This alert may be transmitted to the mobile device via a telephone call, an SMS message, an email message, a social media message, an instant message, or in any other suitable way.

In some embodiments, the alert may be an alert associated with a mobile banking application installed on the mobile device or an alert associated with a mobile banking website. In this regard, an alert associated with a mobile banking application may be displayed on the mobile device shortly after the online banking system determine that the computing device has engaged in the predefined online banking transaction. Alternatively, the alert may not be displayed on the mobile device until the next time the mobile device initiates an online banking session via a mobile banking application or mobile banking website. Once the customer initiates the online banking session using the mobile device via a mobile banking application or mobile banking website, the alert (e.g., an alert icon or other graphical indication) may be displayed on the mobile device through a graphical user interface presented by the mobile banking application or mobile banking website. The mobile banking application or mobile banking website may display information related the computing device engaging in the predefined online banking transaction. For example, the mobile banking application or mobile banking website may display a list or other graphical indication of each device that is currently engaging in a predefined online banking transaction (e.g., each device that is currently logged into the customer's online banking account).

If a mobile device is not associated with the online banking account, then the online banking system typically does not transmit an alert.

Subsequently, at block 240, a remote access command associated with the customer's online banking account and associated with the computing device may be received from the mobile device. The remote access command typically specifies an access parameter and value related to the computing device and to the customer's online banking account. Typically, the remote access command relates to the detected predefined online banking transaction engaged in by the computing device. For example, the remote access command may include a command (e.g., instructions) to allow the predefined online banking transaction. Alternatively, the remote access command may include a command to deny, modify, prevent, or stop the predefined online banking transaction. For example, the remote access command may modify a transaction (e.g., a funds transfer) by reducing the value of the transaction. In addition, the remote access command may include a command for the online banking system to transmit a customer-provided message to the device that initiated the detected predefined online banking transaction. In this, regard the customer may wish to send a message to the user of the device that initiated the detected predefined online banking transaction that this transaction is not authorized.

In addition to the above described access parameters and commands, the remote access command typically includes device identification information associated with the mobile device, device identification information associated with the computing device (e.g., any suitable information for identifying the computing device engaging in the predefined transaction), and account identification information associated with the customer's online banking account. Identification information associated with the mobile device may also act as account identification information. Additional customer or account identification information such as a personal identification number (PIN) or biometric information may be provided by the mobile device (e.g., to the online banking system) in order to further authenticate the identity of the customer. This additional identification information may be provided by the mobile device when initiating a mobile banking application or logging into a mobile banking website. Alternatively, this additional identification information may be provided with the remote access command or after the remote access command has been sent (e.g., upon being prompted by the online banking system to provide additional identification information).

By way of example, after receiving the alert that the computing device has engaged in the predefined transaction, the customer may initiate an online banking session with the mobile device by using a mobile banking application or visiting a mobile banking website. The online banking system may be configured so that the mobile banking application or mobile banking website displays a graphical user interface that displays information regarding the detected predefined online banking transaction and device identification information associated with computing device (e.g., a description of the computing device). The graphical user interface may include one or more buttons proximate to the information regarding the detected predefined online banking transaction that allow the customer to accept, deny, or modify the predefined online banking transaction. Once the appropriate button is pressed, the mobile device may automatically use the mobile banking application or mobile banking website to transmit a suitable remote access command to the online banking system.

Next, at block 250, the online banking system searches the database of records to determine if the device identification information associated with the mobile device is associated with the account identification information contained in the remote access command. If the mobile device is associated with the online banking account, then the method proceeds to block 260. If the mobile device is not associated with the online banking account, then the remote access command may be rejected and an error message may be sent to the mobile device.

At block 260, the remote access of the computing device to the customer's online banking account is modified based upon the remote access command and determining that the mobile device is associated with the customer's online banking account (e.g., that the device identification information associated with the mobile device is associated with the customer's online banking account). For example, if the remote access command is to prevent or stop the predefined online banking transaction, the online banking system may then prevent or stop the predefined online banking transaction, such as preventing a funds transfer or preventing the computing device from logging onto the customer's online banking account. If the remote access command is to allow the predefined online banking transaction, the online banking system may then allow for the transaction to be completed. In this regard, in some embodiments, the online banking system may not complete the predefined online banking transaction until receiving a remote access command from the mobile device to allow the transaction. Alternatively, the predefined online banking transaction may be completed by the online banking system once a predefined time period has elapsed or a remote access command allowing the transaction has been received from the mobile device. Before the predefined online banking transaction is completed, the predefined online banking transaction may be displayed as pending in any online banking session associated with the customer's online banking account. If the remote access command is to modify a transaction (e.g., a funds transfer) by reducing the value of the transaction, the value of the transaction is reduced. If the remote access command is a command for the online banking system to transmit a customer-provided message to the device that initiated the detected predefined online banking transaction, this message is then sent (e.g., via an email or SMS message).

In some embodiments, the online banking system may be configured to record and maintain the history of detected predefined online banking transactions. This history regarding the predefined online banking transactions (e.g., a list of prior successful and unsuccessful attempts to engage in a predefined online banking transaction) may be displayed to the customer (e.g., upon request) via an online banking website or online banking application being accessed by the mobile device.

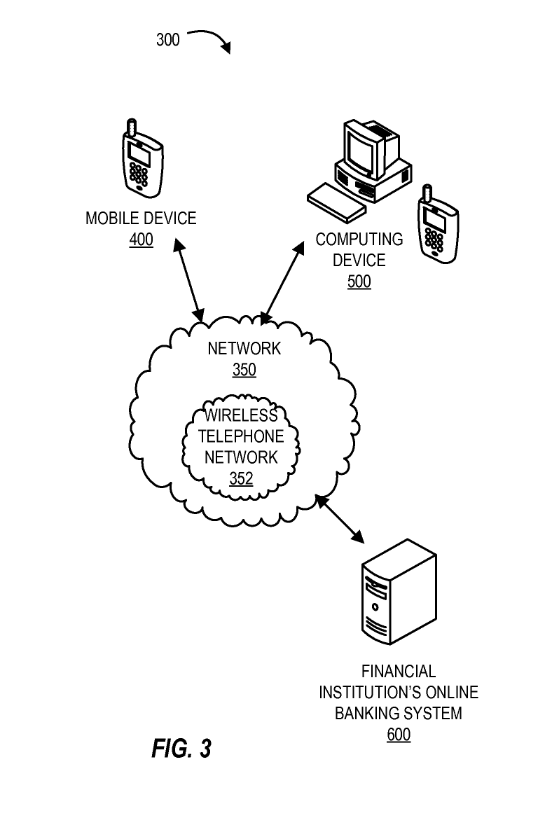

FIG. 3 provides a block diagram illustrating an online banking system 600 and environment 300, in accordance with an embodiment of the present invention. As illustrated in FIG. 3, the online banking environment 300 includes a mobile device 400 associated with an online banking customer and a computing device 500. The computing device may be any device that employs a processor and memory and can perform computing functions, such as a personal computer or a mobile device. As used herein, a “mobile device” is any mobile communication device, such as a cellular telecommunications device (i.e., a cell phone or mobile phone), personal digital assistant (PDA), a mobile Internet accessing device, a tablet computer, a laptop, or other mobile device.

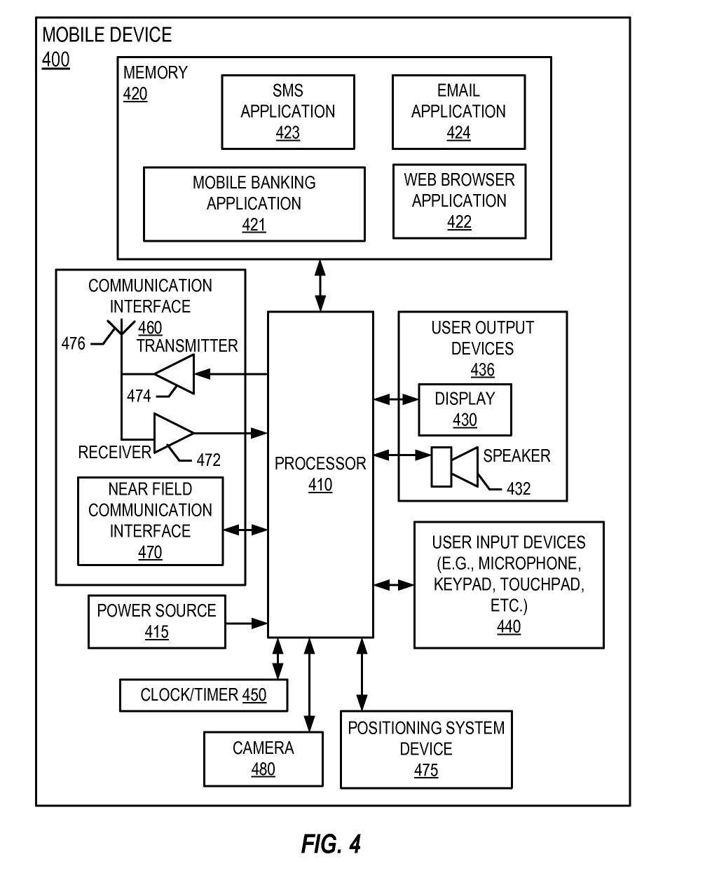

The mobile device 400 and the computing device 500 are typically configured to communicate over a network 350 with a financial institution's online banking system 600. The mobile device 400, the computing device 500, and the financial institution's online banking system 600 are each described in greater detail below with reference to FIGS. 4-6. The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. In one embodiment, the network 350 includes a wireless telephone network 352.

In general, the mobile device 400 is configured to connect with the network 350 to log the customer into an online banking system 600. The online banking system 600 involves authentication of the customer in order to access the customer's account on the online banking system 600. For example, the online banking system 600 is a system where the customer logs into his/her account such that the customer can access data that is associated with the customer. For example, in one embodiment of the invention, the system 600 may be an online banking system maintained by a financial institution. In such an embodiment, the customer can use the mobile device 400 to log into the online banking system to access the customer's online banking account. Logging into the online banking system 600 generally requires that the customer authenticate his/her identity using a user name, a passcode, a cookie, a biometric identifier, a private key, a token, and/or another authentication mechanism that is provided by the customer to the online banking system 600 via the mobile device 400. As described above, the identity of the mobile device 400 may be used to authenticate the identity of the customer.

The financial institution's online banking system 600 is typically in network communication with other devices, such as the computing device 500, which may be configured to communicate with the network 350 to also log the customer into the online banking system 600. In one embodiment, an application download server may be used to download software applications that support the online banking system 600 to the mobile device 400 and/or computing device 500.

In some embodiments of the invention, the application download server is configured to be controlled and managed by one or more third-party data providers (not shown in FIG. 3) over the network 350. In other embodiments, the application download server is configured to be controlled and managed over the network 350 by the same entity that maintains the online banking system 600.

FIG. 4 provides a block diagram illustrating the mobile device 400 of FIG. 3 in more detail, in accordance with embodiments of the invention. In one embodiment of the invention, the mobile device 400 is a mobile telephone. However, it should be understood, however, that a mobile telephone is merely illustrative of one type of mobile device that may benefit from, employ, or otherwise be involved with embodiments of the present invention and, therefore, should not be taken to limit the scope of embodiments of the present invention. Other types of mobile devices may include portable digital assistants (PDAs), pagers, mobile televisions, gaming devices, laptop computers, cameras, video recorders, audio/video player, radio, GPS devices, or any combination of the aforementioned.

The mobile device 400 typically includes a processor 410 communicably coupled to such devices as a memory 420, user output devices 436, user input devices 440, a communication interface 460, a power source 415, a clock or other timer 450, a camera 480, and a positioning system device 475. The processor 410, and other processors described herein, typically includes circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is typically configured to use the communication interface 460 to communicate with one or more other devices on the network 350. In this regard, the communication interface 460 typically includes an antenna 476 operatively coupled to a transmitter 474 and a receiver 472 (together a “transceiver”). The processor 410 is typically configured to provide signals to and receive signals from the transmitter 474 and receiver 472, respectively. The signals may include signaling information in accordance with the air interface standard of the applicable cellular system of the wireless telephone network 352. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN) or other communication/data networks.

The communication interface 460 may also include a near field communication (NFC) interface 470. As used herein, the phrase “NFC interface” generally refers to hardware and/or software that is configured to contactlessly and/or wirelessly send and/or receive information over relatively short ranges (e.g., within four inches, within three feet, within fifteen feet, and the like). The NFC interface 470 may include a smart card, key card, proximity card, Bluetooth® device, radio frequency identification (RFID) tag and/or reader, transmitter, receiver, and/or the like. In some embodiments, the NFC interface 470 communicates information via radio, infrared (IR), and/or optical transmissions. In some embodiments, the NFC interface 470 is configured to operate as an NFC transmitter and/or as an NFC receiver (e.g., an NFC reader). Also, it will be understood that the NFC interface 470 may be embedded, built, carried, and/or otherwise supported in and/or on the mobile device 400. In some embodiments, the NFC interface 470 is not supported in and/or on the mobile device 400, but the NFC interface 470 is otherwise operatively connected to the mobile device 400 (e.g., where the NFC interface 470 is a peripheral device plugged into the mobile device 400). Other apparatuses having NFC interfaces mentioned herein may be configured similarly. In some embodiments, the NFC interface 470 of the mobile device 400 is configured to contactlessly and/or wirelessly communicate information to and/or from a corresponding NFC interface of another apparatus (e.g., another mobile or computing device).

The mobile device 400 typically has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device 400 to receive data from a user such as the customer, may include any of a number of devices allowing the mobile device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 400 may also include a positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In other embodiments, the positioning system device 475 includes a proximity sensor or transmitter, such as an RFID tag, that can sense or be sensed by devices known to be located proximate a location to determine that the mobile device 400 is located proximate these known devices.

The mobile device 400 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which include computer-executable instructions/code executed by the processor 410 to implement the functions of the mobile device 400 described herein. For example, the memory 420 may include such applications as a conventional web browser application 422 and/or a mobile banking application 421. These applications also typically provide a graphical user interface (GUI) on the display 430 that allows the customer to communicate with the consumer mobile device 400, the online banking system 600, and/or other devices or systems. In one embodiment of the invention, when the customer decides to enroll in the online banking program, the customer downloads or otherwise obtains the mobile banking system client application from the online banking system 600 or from a distinct application server. In other embodiments of the invention, the customer interacts with the online banking system 600 via the web browser application 422 in addition to, or instead of, the mobile banking application 421. The online banking system 600 is typically configured to present a graphical user interface (e.g., through a mobile banking application or mobile banking website) that allows the customer to use the mobile device 400 to control access to the customer's online banking account. In this regard, the graphical user interface may include buttons (e.g., “deny,” “allow,”” “on,” “off,” “lock,” or “unlock”) that allow the customer to control the access of the computing device 500 to the customer's online banking account.

The memory 420 can also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information.

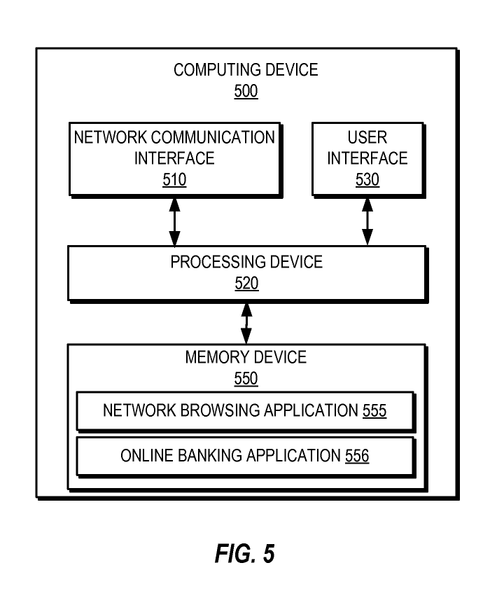

Referring now to FIG. 5, the computing device 500 also includes various features, such as a network communication interface 510, a processing device 520, a user interface 530, and a memory device 550. The network communication interface 510 includes a device that allows the personal computing device 500 to communicate over the network 350 (shown in FIG. 3). In one embodiment of the invention, a network browsing application 555 provides for a user to establish network communication with the online banking system 600 (shown in FIG. 3) for the purpose accessing a customer's online banking account. In another embodiment, an online banking application 556 allows the user of the computing device 500 to a customer's online banking account. In addition, the online banking application 556 may be configured to transmit location information associated with the computing device to the online banking system 600. Accordingly, the computing device 500 may include any suitable positioning system device (e.g., a GPS transceiver) for determining the location of the computing device 500. Furthermore, the computing device 500 may be configured to transmit information about the wireless communication network that it is on to the online banking system 600.

As used herein, a “processing device,” such as the processing device 520, generally refers to a device or combination of devices having circuitry used for implementing the communication and/or logic functions of a particular system. For example, a processing device 520 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 520 may further include functionality to operate one or more software programs based on computer-executable program code thereof, which may be stored in a memory. As the phrase is used herein, a processing device 520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 530 generally includes a plurality of interface devices and/or software that allow a customer to input commands and data to direct the processing device to execute instructions. For example, the user interface 530 presented in FIG. 5 may include a graphical user interface (GUI) or an interface to input computer-executable instructions that direct the processing device 520 to carry out specific functions. The user interface 530 employs certain input and output devices to input data received from the customer or output data to the customer. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” 550 generally refers to a device or combination of devices that store one or more forms of computer-readable media for storing data and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein.

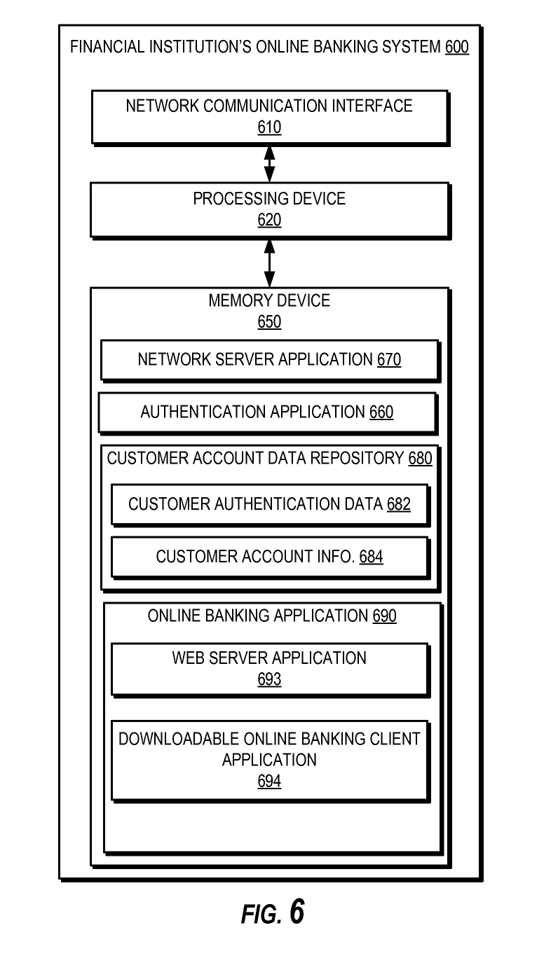

FIG. 6 provides a block diagram illustrating the online banking system 600 in greater detail, in accordance with an embodiment of the invention. As illustrated in FIG. 6, in one embodiment of the invention, the online banking system 600 includes a processing device 620 operatively coupled to a network communication interface 610 and a memory device 650. In certain embodiments, the online banking system 600 is operated by a financial institution, while in other embodiments, the online banking system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the online banking system 600 described herein. For example, in one embodiment of the online banking system 600, the memory device 650 includes, but is not limited to, a network server application 670, an authentication application 660, a customer account data repository 680 which includes customer authentication data 680 and customer account information 684, an online banking application 690 which includes a web server application 693, a downloadable online banking client application 694, and other computer-executable instructions or other data. The computer-executable program code of the network server application 670, the authentication application 660, or the online banking application 690 may instruct the processing device 620 to perform certain logic, data-processing, and data-storing functions of the online banking system 600 described herein, as well as communication functions of the online banking system 600.

In one embodiment, the customer account data repository 680 includes customer authentication data 682 and customer account information 684. The network server application 670, the authentication application 660, and the online banking application 690 are configured to implement customer account information 684 and the customer authentication data 682 (e.g., customer identification information) when authenticating a customer to the online banking system 600. In this regard, the customer authentication data 682 may include a customer's username, password, PIN number, and device identification information associated with an enrolled mobile device. The customer account information 684 may include account identification information, association records related to one or more enrolled mobile devices.

As used herein, a “communication interface” typically includes a modem, server, transceiver, and/or other device for communicating with other devices on a network, and/or a user interface for communicating with one or more customers. Referring again to FIG. 6, the network communication interface 610 is a communication interface having one or more communication devices configured to communicate with one or more other devices on the network 350, such as the mobile device 400, the computing device 500, and the online banking system 600. The processing device 620 is typically configured to use the network communication interface 610 to transmit and/or receive data and/or commands to and/or from the other devices connected to the network 350.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

To supplement the present disclosure, this application further incorporates entirely by reference the following commonly assigned patent applications: U.S. patent application Ser. No. ______ for a “Remote Control for Online Banking,” filed Jul. 19, 2013; U.S. patent application Ser. No. ______ for “Customer-Defined Online Banking Access Restrictions,” filed Jul. 19, 2013; U.S. patent application Ser. No. ______ for “Restricted Access to Online Banking,” filed Jul. 19, 2013; U.S. patent application Ser. No. ______ for “Offline Mobile Banking,” filed Jul. 19, 2013; U.S. patent application Ser. No. ______ for “Completing Mobile Banking Transactions from Trusted Location,” filed Jul. 19, 2013; U.S. patent application Ser. No. ______ for “Completing Mobile Banking Transaction with Different Devices,” filed Jul. 19, 2013; U.S. patent application Ser. No. ______ for an “Online Session Transfer,” filed Jul. 19, 2013; and U.S. patent application Ser. No. ______ for “Systems for Managing Account Aggregators Access to Financial Account Information,” filed Jul. 19, 2013.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for providing alerts regarding a customer's online banking account, comprising:
a computer apparatus including a processor and a memory; and
an online banking module stored in the memory, executable by the processor and configured for:
receiving an association request from the customer to associate a first mobile device with the customer's online banking account, the association request comprising device identification information associated with the first mobile device and first account identification information associated with the customer's online banking account;
associating the device identification information associated with the first mobile device with the customer's online banking account and creating an association record based on the device identification information associated with the first mobile device and the first account identification information associated with the customer's online banking account;
determining whether a computing device has engaged in a predefined online banking transaction associated with the customer's online banking account;
searching a database of records to determine if a mobile device is associated with the customer's online banking account; and
transmitting a notification that the computing device has engaged in the predefined online banking transaction to the first mobile device based on determining that (i) the computing device has engaged in the predefined online banking transaction associated with the customer's online banking account and (ii) the first mobile device is associated with the customer's online banking account.

2. The system according to claim 1, wherein the online banking remote control module is configured for:
after transmitting the notification to the first mobile device, receiving a remote access command associated with the customer's online banking account from the first mobile device, the remote access command comprising the device identification information associated with the first mobile device, device identification information associated with the computing device, and second account identification information associated with the customer's online banking account;
searching a database of records to determine if the first mobile device is associated with the customer's online banking account; and
modifying the remote access of the computing device to the customer's online banking account based on the remote access command and determining that the first mobile device is associated with the customer's online banking account.

3. The system according to claim 2, wherein:
the remote access command comprises instructions to prevent the computing device from engaging in the predefined online banking transaction; and
modifying the remote access of the computing device to the customer's online banking account comprises preventing the computing device from engaging in the predefined online banking transaction.

4. The system according to claim 1, wherein the predefined online banking transaction comprises initiating an online banking session.

5. The system according to claim 1, wherein the predefined online banking transaction comprises a funds transfer.

6. The system according to claim 1, wherein the predefined online banking transaction comprises engaging in an online banking transaction from a predefined location.

7. The system according to claim 1, wherein the predefined online banking transaction comprises a sub-account associated with the customer's online banking account engaging in an online banking transaction.

8. The system according to claim 1, wherein the predefined online banking transaction is defined by the customer.

9. A computer program product for providing alerts regarding a customer's online banking account, comprising a non-transitory computer-readable storage medium having computer-executable instructions for:
receiving an association request from the customer to associate a first mobile device with the customer's online banking account, the association request comprising device identification information associated with the first mobile device and first account identification information associated with the customer's online banking account;
associating the device identification information associated with the first mobile device with the customer's online banking account and creating an association record based on the device identification information associated with the first mobile device and the first account identification information associated with the customer's online banking account;
determining whether a computing device has engaged in a predefined online banking transaction associated with the customer's online banking account;
searching a database of records to determine if a mobile device is associated with the customer's online banking account; and
transmitting a notification that the computing device has engaged in the predefined online banking transaction to the first mobile device based on determining that (i) the computing device has engaged in the predefined online banking transaction associated with the customer's online banking account and (ii) the first mobile device is associated with the customer's online banking account.

10. The computer program product according to claim 9, wherein the non-transitory computer-readable storage medium has computer-executable instructions for:
after transmitting the notification to the first mobile device, receiving a remote access command associated with the customer's online banking account from the first mobile device, the remote access command comprising the device identification information associated with the first mobile device, device identification information associated with the computing device, and second account identification information associated with the customer's online banking account;
searching a database of records to determine if the first mobile device is associated with the customer's online banking account; and
modifying the remote access of the computing device to the customer's online banking account based on the remote access command and determining that the first mobile device is associated with the customer's online banking account.

11. The computer program product according to claim 10, wherein:
the remote access command comprises instructions to prevent the computing device from engaging in the predefined online banking transaction; and
modifying the remote access of the computing device to the customer's online banking account comprises preventing the computing device from engaging in the predefined online banking transaction.

12. The computer program product according to claim 9, wherein the predefined online banking transaction comprises initiating an online banking session.

13. The computer program product according to claim 9, wherein the predefined online banking transaction comprises a funds transfer.

14. The computer program product according to claim 9, wherein the predefined online banking transaction comprises engaging in an online banking transaction from a predefined location.

15. The computer program product according to claim 9, wherein the predefined online banking transaction comprises a sub-account associated with the customer's online banking account engaging in an online banking transaction.

16. The computer program product according to claim 9, wherein the predefined online banking transaction is defined by the customer.

17. A method for providing alerts regarding a customer's online banking account, comprising:
receiving, with a computer processor, an association request from the customer to associate a first mobile device with the customer's online banking account, the association request comprising device identification information associated with the first mobile device and first account identification information associated with the customer's online banking account;
associating, with a computer processor, the device identification information associated with the first mobile device with the customer's online banking account and creating an association record based on the device identification information associated with the first mobile device and the first account identification information associated with the customer's online banking account;
determining, with a computer processor, whether a computing device has engaged in a predefined online banking transaction associated with the customer's online banking account;
searching, with a computer processor, a database of records to determine if a mobile device is associated with the customer's online banking account; and
transmitting, with a computer processor, a notification that the computing device has engaged in the predefined online banking transaction to the first mobile device based on determining that (i) the computing device has engaged in the predefined online banking transaction associated with the customer's online banking account and (ii) the first mobile device is associated with the customer's online banking account.

18. The method according to claim 17, comprising:
after transmitting the notification to the first mobile device, receiving a remote access command associated with the customer's online banking account from the first mobile device, the remote access command comprising the device identification information associated with the first mobile device, device identification information associated with the computing device, and second account identification information associated with the customer's online banking account;
searching a database of records to determine if the first mobile device is associated with the customer's online banking account; and
modifying the remote access of the computing device to the customer's online banking account based on the remote access command and determining that the first mobile device is associated with the customer's online banking account.

19. The method according to claim 18, wherein:
the remote access command comprises instructions to prevent the computing device from engaging in the predefined online banking transaction; and
modifying the remote access of the computing device to the customer's online banking account comprises preventing the computing device from engaging in the predefined online banking transaction.

20. The method according to claim 17, wherein the predefined online banking transaction comprises initiating an online banking session.

21. The method according to claim 17, wherein the predefined online banking transaction comprises a funds transfer.

22. The method according to claim 17, wherein the predefined online banking transaction comprises engaging in an online banking transaction from a predefined location.

23. The method according to claim 17, wherein the predefined online banking transaction comprises a sub-account associated with the customer's online banking account engaging in an online banking transaction.

24. The method according to claim 17, wherein the predefined online banking transaction is defined by the customer.
